(19) United States
(12) Patent Application Publication
(10) Pub. No.: US 2004/0068418 A1
(43) Pub. Date: Apr. 8, 2004

(54) Method and apparatus for issuing product notices

(76) Inventor: Jack I. J'maev, Chino, CA (US)

Correspondence Address: Jack J'maev, SUITE 110, 11800 CENTRAL AVE., CHINO, CA, 91710, US

(21) Appl. No.: 10/615,345

(22) Filed: Jul. 7, 2003

Related U.S. Application Data
(60) Provisional application No. 60/394,980, filed on Jul. 9, 2002.

(51) Int. Cl. G06F 17/60

(52) U.S. Cl. 705/1

(57) ABSTRACT

System and method for issuing an electronic signal to a product. Electronic signal is address directed to product based on product identification such as SKU number, lot/date codes and serial numbers. Other intermediate identifiers are also used. Electronic signal can be recall signal with various levels of criticality. Electronic signal can be transmitted on periodic basis.

### RELATED APPLICATIONS

This present application is related to a provisional application serial No. 60/394,980 filed on Jul. 9, 2002, entitled “Method and Apparatus for Product Recall”, by J'maev, currently pending, for which the priority date for this application is hereby claimed.

### BACKGROUND OF THE INVENTION

1. Technical Field

This invention pertains to the field of managing recall of products; specifically to a method and apparatus for issuing recall signals.

2. Description of the Prior Art

Consumer goods, domestic appliances and industrial equipment are becoming more and more complex. Although extensive material quality and process controls are in place, some defects in these products may not be discovered until the product is in the supply channel or in use. Once products are shipped, they could be in a number of locations including distributor warehouses, shipping docks or they may be in transit. In many cases a product that is the subject of a recall may have already been delivered to a consumer and placed in service.

Shipment of a product with a defect has several important implications. These include but are not limited to safety, customer confidence and financial loss. In the event of a dangerous incident, the end user may sustain bodily injury as well as financial loss. The manufacturer and other companies including its distributor and reseller may also experience a financial loss. Safety concerns may, inter alia, relate to fire, flood, dangerous food preparation, injury from moving apparatus, chemical, nuclear or biological hazards. These are but some examples of types of losses that can result from the use of defective products.

Manufacturing companies use various systems in order to ensure recall of a defective product. The goal of a recall system is to contact and provide corrective action instructions to the user. Some of the currently employed recall systems try to achieve this goal by providing a means to identify the defective product and determine its location. How well a defective product can be identified is called “traceability”. Traceability is generally achieved through the use of serial numbers for particular products. The serial numbers of defective units together with batch and date codes may also be used to identify entire lots of defective component parts. Traceability procedures enable the identification of specific products that may be defective due to material or manufacturing defects. Traceability procedures do not of themselves enable the manufacturer to know the physical location of a product. Physical location of the product is normally important in order to identify the current user who may be exposed to the dangers associated with continued product use.

Even though it may be possible to isolate defective products through traceability, locating the product after it has left the factory shipping dock is problematic. Product may be sold to installers and retail outlets rather than directly to the end users themselves. New products may be sold to a first customer who subsequently sells the product, in a used condition, to a second customer. In this case both the location of the defective product and the identity of the user are unknown.

So far, a number of systems have been devised to allow the product to be traced after it has left the factory. One way that this has been achieved in the past is to encourage the registration of the product by the user. In registration, the product manufacturer may receive user information by way of a postcard. On-line systems may be employed for product registration as well. A second way is for resellers and distributors to maintain records of end customers as product is delivered in order to obtain the whereabouts of the products. These systems are generally unreliable, slow, time consuming for those involved and costly. As a last resort or where injuries or other safety incidents are known to have occurred, recall notices may be issued either by direct mail, use of safety organizations' web sites, press releases, advertising in television or newspaper media or other means.

A recall notice attempts to guide the reader through the process of identifying the defective product. The recall notice may, inter allia, include company name, description of affected models and how to identify them, associated brand names, where they may have been sold and a range of prices used by the retail outlets over the period in which the products were sold. The issuer of the recall notice also describes inter allia the number of items affected, the nature of the defect and how it affects the use of the product. Specific details of confirmed and unconfirmed incidents may be followed by instructions for the user such as “unplug”, “do not use”, “call toll-free number”. In cases where there exists one of the aforementioned safety concerns it is important that the user clearly understands the instructions and responds swiftly.

One prior art method for recall would be to consult manufacturing records to identify affected products. The matching of these records to sales details recorded by sales personnel and provided by end customers in their registration cards allows the original customer to be identified. The recall notice is then mailed to each individual customer. In an alternative prior art method, the consumer may be advised to consult recall information that may be posted on an Internet website and perform a search for all products the consumer may have or intends to purchase.

In whichever way the recall information is conveyed to the user, the involvement of a customer in checking serial numbers is error prone and may also affect customer confidence. Despite the best intentions of the manufacturer and other interested parties, it is uncertain that the end user will read the recall notice, even if the recall notice has been mailed to the correct address. By way of illustration of this point, consider that the lack of response to a toll free number could be the result of customer disenchantment with the manufacturer or resale agents rather than the result of the customer failing to read the recall notice.

Recall notices will not reach customers to which product has not yet been shipped, and importers/distributors/resellers may not have kept adequate records of serial numbers and other product information which would link a known defective product to the user. Possibly the most significant shortcoming of all prior art methods of recall by direct contact with the original purchaser is that they do not take into account the subsequent relocation of the original user or resale of the product. Indeed, a prospective purchaser may be unaware of the recall status and therefore the inherent danger associated with the product that is being offered for sale.

A number of websites, such as that hosted by the US Consumer Product Safety Commission, have been established as central repositories for recall notices. These do allow anybody with Internet access to view a participating manufacturers' recall notices. However, end users would still need to be aware of the website, check the information provided therein and decide for themselves if they were affected by the recall.

In so far as the manufacturer maintains detailed records of manufacture and component origin, defective product can normally be readily identified. It is unfortunate that this ability to easily and uniquely identify a defective product is lost the moment it leaves the physical locations that are under the immediate control of the manufacturer. That the current user of the product cannot always be known prevents successful recall. This means that potential danger to life, limb and property cannot be avoided.

### SUMMARY

The present invention comprises a method for issuing a notice to product. According to one example method, a product identifier is accepted. The product identifier, according to one illustrative method, is associated with a single product. According to one alternative method, the product identifier is associated with a group of products. Once the product identifier is accepted, a signal message is generated based on the product identifier. The signal message is then conveyed to the product.

According to one example method, a product identifier is accepted in various forms including, but not limited to a stock keeping unit (SKU) number, a serial number a lot code and a date code. According to yet another illustrative variation of the present method, the signal message includes the product identifier. According to yet another example variation of the present method, a digital identification number that is associated with the product (or group of products) is determined. This digital identification number is then included in the signal message.

Conveying the signal message to the product, according to one illustrative variation of the present method, is accomplished by determining a target product group in the determining a communications channel for the target product group. It should be noted that the target product group can include only a single product or a collection of products. Once the proper communications channel has been determined, the signal message is then conveyed to the communications channel. He to one example method, determining the correct communications channel comprises determining one or more of a carrier frequency, a numeric sequence (e.g. a pseudorandom number sequence), a network address and a telephone number.

According to one illustrative method of the present invention, the signal message is conveyed to the product by first determining a conveyance time slot that is associated with the product (or target product group). Then, the signal message is conveyed to the communications channel during the appropriate conveyance time slot. In order to ensure that a receiving means is properly synchronized with a transmitting station, one variation of the present method provides for conveying a time beacon to the product. This is accomplished by conveying a time beacon message to the determined communications channel.

Various forms of communications channels are used by alternative methods of the present invention. For example one alternative method relies on a wired communications medium. A second alternative method provides for the use of a wireless communications medium. According to yet another alternative method, a signal message is conveyed to a product by means of the cable television distribution system. According to yet another alternative method, a utility power distribution system is used to convey a signal to a product. According to yet another alternative method, a switched telephone network is utilized to convey a signal message to a product. Both cellular and conventional wired telephone infrastructures are included in the present invention's definition of a switched telephone network.

The invention further comprises an apparatus for conveying a notice to a product. One example embodiment of such an apparatus comprises a product identification unit, a signal generator and a signal transmitter. According to one example embodiment, the product identification unit is capable of accepting one or more of a SKU number, a serial number is a lot code and a date code. The signal generator generates a signal message based on a product identifier received by the product identification unit. Accordingly, the signal message generated by the signal generator, according to one alternative embodiment, includes the product identifier. In yet another alternative embodiment, the signal generator determines or receives a digital identification number that is associated with the product identifier. This digital identification number is then included in the signal message generated by the signal generator.

According to one example embodiment of the present invention, the signal transmitter comprises a channel indicator receiver is capable of receiving a channel indicator. The signal transmitter further comprises an interface. The signal transmitter dispatch is the signal message generated by the signal generator according to the channel indicator. For example, the interface in one embodiment of the invention comprises the radio frequency interface (e.g. a transmitter). Accordingly, the channel indicator can be used to set the frequency of the radio frequency interface. According to yet another example embodiment, the interface comprises a spread spectrum interface. Accordingly, the channel indicator can be used to convey a numeric sequence to spread spectrum interface that controls frequency hopping. According to yet another example embodiment, the channel indicator is used to control a network interface that is used to convey the signal message to a wide area network wherein the signal message is addressed to a particular product or group of products (i.e. the target product group). Other example of interface types include, but are not limited to a cable television interface, a utility power interface and a switched telephone network interface.

According to yet another illustrative embodiment of the present invention, the signal transmitter is capable of conveying the signal message to the product during a particular time slot. According to yet another example embodiment, the signal transmitter conveys the signal message to the product on a periodic basis. The signal transmitter of yet another example embodiment is capable of conveying a time beacon to the product.

### BRIEF DESCRIPTION OF THE DRAWINGS

The foregoing aspects are better understood from the following detailed description of one embodiment of the invention with reference to the drawings, in which:

FIG. 1 is a flow diagram that depicts one illustrative process for issuing a recall notice to a product according to the present invention;

FIG. 2 is a flow diagram that illustrates optional steps associated with one variation of the present method for receiving an acknowledgment from a product that a recall notice was received;

FIG. 3 is a pictorial representation of one possible structure of a table that may be used to record and subsequently discover the channel that may be used to issue a recall signal to a particular product and/or group of products according to the present invention;

FIG. 4 is a pictorial representation of one example structure of a recall attempt table that may be used to record instances of recall signals that may be disseminated to a particular product according to the present invention;

FIG. 5 is a pictorial representation of one possible structure of a notice type table that may be used according to the present invention to manage recall notices;

FIG. 6 is a pictorial representation that illustrates one possible method for time-multiplexing a communications channel into a plurality of time slots according to the present invention;

FIG. 7 is a pictorial representation of a recall management system that may be used to issue a recall signal to a product according to the present invention;

FIG. 8 is a flow diagram that depicts one example process for receiving a product recall signal according to the present invention;

FIG. 9 is a flow diagram that depicts one illustrative, alternative method for receiving a recall signal during a particular time slot according to the present invention; and

FIG. 10 is a block diagram of one example embodiment of a receiving means that may receive a recall signal according to the present invention.

### DETAILED DESCRIPTION OF THE INVENTION

The present invention comprises a method for issuing a recall notice directly to a product that is the subject of a recall. According to one method of the present invention, information regarding products is maintained either by the manufacturer, distributor or other entity. Generally, a means for receiving a recall notice is integrated into a product. Upon receiving a recall notice, the receiving means provides an indication to a user that a recall of the product is pending. The present invention also comprises an apparatus for maintaining information about products. This apparatus is called a “recall management system” (RMS). This RMS apparatus further comprises a means for conveying a recall notice to a product. The present invention also comprises yet a separate apparatus that is integrated into a product and that receives a recall notice disseminated by the RMS. This apparatus is referred to as a “recall notice detector” (RND).

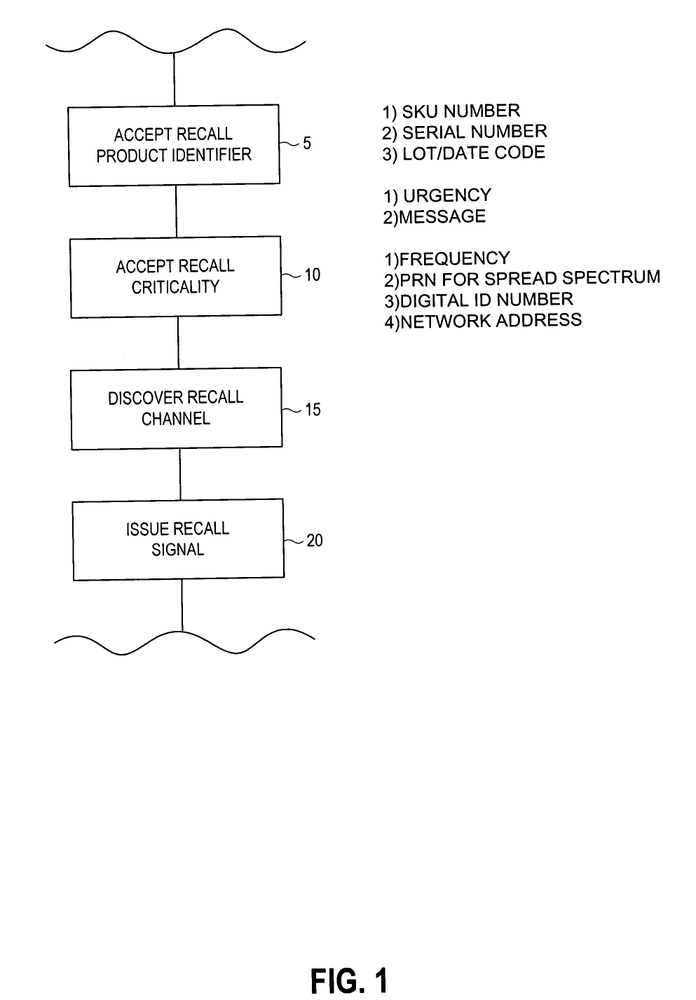

FIG. 1 is a flow diagram that depicts one illustrative process for issuing a recall notice to a product according to the present invention. Manufacturers have long maintained records that enable them to issue recall notices to users in the event a product is discovered to be defective. A product may also be recalled for other purposes. But clearly, the most common reason a manufacturer issues a recall notice is to reduce potential liability that may result from the continued use of a defective product. Product may be defective either in design, manufacture or some other flaw. It should be noted that the actual cause of the malfunction or defect of a product is irrelevant and is not intended to limit the scope of the present invention.

According to this illustrative method, the first step in issuing a recall notice is that of accepting an identifier for a product that is the subject of the recall (step 5). The present invention contemplates the use of various methods for accepting a product identifier. For instance, one variation of the present method provides that acceptance of a product identifier comprises acceptance of a stock keeping unit number, i.e. “SKU”. According to an alternative method, a product identifier is accepted by accepting a model number. According to yet another variation of the illustrative method, serial numbers may be used to identify a particular product. Hence, acceptance of the product identifier comprises acceptance of a serial number. Lot numbers and/or date codes may also be used to identify a group of products that may need to be recalled. Hence, one alternative method provides for accepting one or more of a lot number and date code as a product identifier. The present method may rely on any other convenient means for identifying either a single product or a group of products that may be the subject of a recall and the scope of the present invention is not intended to be limited by any examples provided thus far. Typically, the product identifier is said to comprise a product index that is used to access data in tables maintained in the RMS.

Whenever a manufacturer considers the issuance of a recall notice, it generally must consider the urgency with which the recall notice must be issued. In many cases, the nature of the defect that has spawned the need for a recall notice may dictate the method of recall notice issuance. According to one variation of the present method, urgency of the recall is represented by a defect category. Some possible examples of defect categories that are not intended to limit the scope of the present invention include “minor defect”, “major defect” and “life-threatening defect”. In the case where a minor defect is driving the need for a product recall, the corrective action may be minor and there may not be any impending threat to personal safety. On the other extreme, life-threatening defects may require immediate attention by the consumer in possession of a defective product. Typically, life-threatening defects may require immediate, discontinued use of the product. Hence, one variation of the present method provides for a step for accepting a recall criticality level (step 10). When so accepted by a process adhering to the present method, the criticality level is used to represent the level of danger that may be associated with the continued use of a defective product.

According to one illustrative method of the present invention, the recall notice is conveyed directly to a product or group of products. In order to enable this type of functionality, the method of the present invention provides for the determination of a communication channel (step 15) that is used to convey the recall notice to the target product or group of products. Various means may be used to convey the recall notice to either a single, individual product or to a group of products. The products that are the subject of a recall are referred to as a target product group; this group may comprise either a single product or a group of products.

According to one variation of the present method, the communications channel comprises a single radio frequency that is used to convey a recall signal to a target product group. According to one alternative method, only a single communications channel is used to convey the recall signal to one or more target product groups. In this case, the step of determining a communications channel to the product is not required every time a recall signal is conveyed to the channel. Typically, the one channel is determined either immediately prior to conveyance of a recall signal to the channel, or at some time prior to said conveyance. According to one variation of the present method, the recall signal is conveyed by means of a spread-spectrum communications system. In such a case, a single or numerous channels are carried by the spread-spectrum system. Where numerous channels are carried by a spread-spectrum system, channels are distinguished through the use of separate and distinct pseudorandom number (PRN) sequence for controlling frequency hopping in the spread-spectrum communications system. Other conveyance methods may also be used.

All of these conveyance methods may be modified by using a digital identification number that corresponds to a particular product and/or group of products. According to one variation of the present method, the digital identification number is based on the product identifier (e.g. it comprises the product identifier). Hence, one variation of the present method uses a single frequency to convey a recall signal wherein the recall signal comprises a digital identification number. Likewise, a PRN selected spread-spectrum channel carries a recall signal that comprises a digital identification number. A product may receive a signal and may then use the digital identification number to determine if the signal is intended for that product.

In yet another variation of the inventive method, the recall signal is conveyed to a particular product and/or group of products through a networking structure. Hence, a network address is used to direct the signal to a single product and/or group of products. The method of the present invention may rely on conveying the recall signal to a product by means of either a wired or wireless networking structure. For example, one example method directs the recall signal to a product by means of a telephone connection. In yet another example method, the recall signal is directed to a product by means of a cellular telephone connection. In either of these two illustrative methods, the digital identification number used to direct a recall signal to a product comprises a telephone number that is associated with the product.

It should be noted that conveyance of a recall signal to a product need not necessarily be accomplished by wireless techniques. In fact, the scope of the present invention is intended to include methods that rely on wired interfaces.

Wireless dissemination techniques may be suitable for a certain class of product; mobile homes, automobiles, motorcycles, boats, model airplanes and camping equipment are just some examples of products that may be best signaled by a wireless means. Other types of products may also be signaled using wireless dissemination techniques. These other types of products may include products that have traditionally been used in a non-tethered fashion, i.e. they do not require a wired connection for power or primary function signaling. These may include, but are not necessarily limited to products such as infant car safety seats, sleeping cribs and other various toys for infants and children. All of these enumerations are meant to illustrate possible applications of wireless recall signaling techniques and are not intended to limit the scope of the present invention.

According to one derivative method of the present invention, a recall signal is carried by a cable television (TV) signal carried by a coaxial cable or analog fiber from a head-end and propagated to devices that may be attached to the television signal distribution network. This wired technique is applicable to television sets and entertainment equipment that may be attached to the cable TV system.

According to yet an alternative method that illustrates the present invention, a recall signal is carried by means of telephone wiring. In such cases, the telephone wiring is used to support some form of out-of-band signaling that may be received by a particular type of product.

According to yet another variation of the inventive method, the recall signal is carried by utility power lines that convey electrical power to households, businesses, factories, schools and the like. These are just some examples of the type of facilities that receive power through a utility service and this list is not meant to limit the scope of the present invention. This example of a wired conveyance technique may be applicable to products such as television sets, microwave ovens, refrigerators, washers and dryers and sundry power tools. Heavy manufacturing tools may also comprise products that employ this method to receive a recall signal. Generally, the method of the present invention may rely on the most appropriate conveyance method for a particular product and the examples presented here are intended to illustrate the concepts of the present method and are not intended to limit the scope of the present invention. In fact, the present method contemplates the use of all practical conveyance techniques and it is the intent of the present disclosure to include all such practical conveyance techniques in the scope of the present invention.

According to one additional variation of the present method, the channel that is used to recall a particular product is time-shared amongst a wide variety of products or individual products in a product group. Hence, according to this variation of the method, the channel is only used to signal a particular product and/or group of products during a particular time slot. A time slot may be any interval of time comprising a cyclical signaling period comprising a plurality of time slots. According to one variation of the present method, a recall or other type of product notice signal is transmitted according to this cyclical signaling period. Hence, according to this alternative method, the signal is constantly repeated so that a receiver may receive the signal during a particular time slot.

Once the proper recall channel has been identified, one example method provides for the issuance of a recall signal (step 20). The recall signal may then be received by either a single product or group of products. It should be noted that the present method does not require that the recall signal should actually be received.

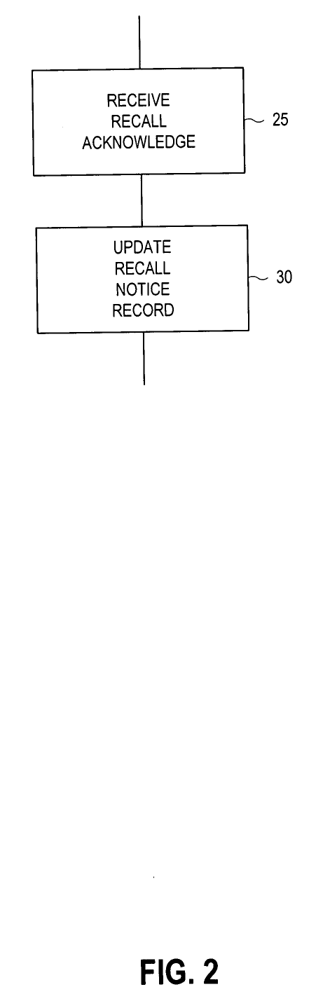

FIG. 2 is a flow diagram that illustrates optional steps associated with one variation of the present method for receiving an acknowledgment from a product that a recall notice was received. In some situations, issuing a recall notice and then relying on the receiving means integrated in a product is not sufficient to reduce product liability that a manufacturer may incur as a result of continued use of a defective product. Accordingly, one alternative method of the present invention provides that the receiving means actively acknowledge receipt of a recall signal. The method of the present invention provides for receipt of the recall acknowledgment (step 25) followed by an update of a recall notice record (step 30) that is maintained by the manufacture or other entity that is charged with issuing the recall signal.

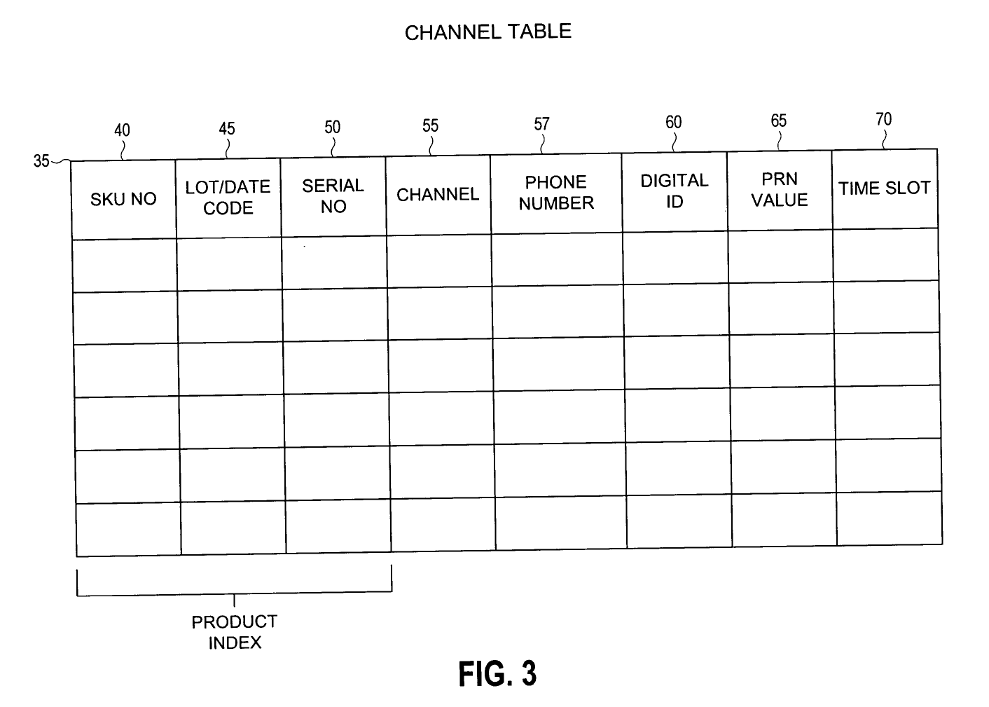

FIG. 3 is a pictorial representation of one possible structure of a table that may be used to record and subsequently discover the channel that may be used to issue a recall signal to a particular product and/or group of products according to the present invention. According to one alternative embodiment, a recall management system uses a channel table 35 to associate a particular channel with a particular product and/or group of products. One illustrative method of the present invention that illustrates this concept utilizes a channel table 35 comprising a SKU number field 40. In yet another alternative method, the channel table 35 comprises a lot/date code field 45. According to one variation of this method, the lot and date codes comprise separate fields in the channel table 35. In yet another alternative method, only a lot field is utilized. According to another variation of the present method, only a data field is utilized. In those alternative methods that use a product serial number to identify a particular product that should be recalled, the channel table 35 comprises a serial number field 50. Some embodiments of the invention use a digital identifier to identify a target product group. In these embodiments, the channel table 35 comprises a digital identifier field 60 that is used to store a digital identification number. It should be noted that the digital identification number is used as a network address by one variation of the present method that conveys a recall signal to a product using a networking structure. In those alternative methods that utilize spread-spectrum communications systems to convey the recall signal to a product, the channel table 35 further comprises a PRN value field 65 that may be used to store an identifier corresponding to a PRN sequence used to control a frequency hopping sequence in the spread-spectrum communication system. In those illustrative methods that time-share a channel amongst a wide variety of products, the channel table 35 further comprises a time slot field 70 that is used to indicate what time slot should be used to convey a signal to a particular product. According to one alternative method, a telephone number is used to determine the target product. Hence, one embodiment of the channel table 35 comprises a telephone number field 57.

In operation, these various illustrative methods consult the channel table 35 in order to discover what channel should be used to convey a recall signal to a particular product. Generally, this is accomplished by using a particular product identifier as an index into the channel table 35. In the example methods taught here, the SKU number field 40, the lot/date code field(s) 45 and the serial number field 50 may all be used individually or collectively and in any combination as a product index into the channel table 35. Once a particular record is identified by such a product index, the method of the present invention retrieves one or more of a channel number, a digital identifier number, a PRN value, a telephone number and a time slot number from corresponding fields in the selected record stored in the channel table 35. Depending on which variation of the present method is used to issue a recall signal, the channel number (which according to one example method corresponds to a particular radio frequency), the digital identifier number, the PRN value and the time slot number are used either individually, collectively or in any combination in order to specify a channel that may be used to convey a recall signal to a particular product or group of products. Accordingly, a channel to a product is determined in such manner.

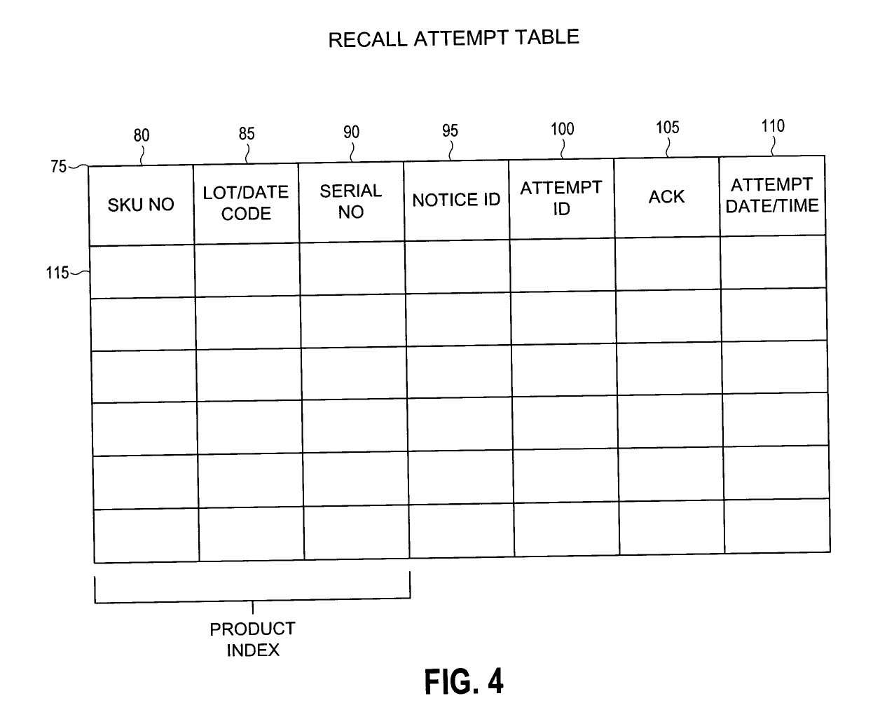

FIG. 4 is a pictorial representation of one example structure of a recall attempt table that is used by one illustrative method to record instances of recall signals disseminated to a particular product according to the present invention. According to one method of the present invention, a product recall signal is generally disseminated to a product and/or group of products only one time. According to yet another alternative method of the present invention, a plurality of recall signals are disseminated in order to increase the probability that the receiving means comprising the products is able to receive the recall signal. This is typically accomplished on a periodic basis.

In order to provide a legal foundation to support a manufacturer's claim that a recall signal was issued numerous times, one method of the present invention records each instance of a recall signal issuance in a recall attempt table 75. Various derivatives of this method utilize a recall attempt table 75 that comprises one or more of a SKU number field 80, the lot/date code field 85 and a serial number field 90. Depending on the type of product identification means utilized by a particular variation of the present method, the SKU number field 80, the date/lot code field 85 and the serial number field 90 may be used separately, collectively or in any combination as an index into the recall attempt table 75. Using the appropriate product index, the recall attempt table 75 is used to store one or more recall attempt records 115. Where more than one attempt record must be stored for a particular product index, the recall attempt table 75 further comprises an attempt identifier field 100. The attempt identifier field 100 is used to distinguish amongst a plurality of attempt records for a particular product index.

According to one variation of the inventive method, various types of product recall notices are disseminated. Typically, each variety of product recall notice is distinguished by a notice identifier. In these variations of the inventive method, the recall attempt table 75 further comprises a notice identifier field 95. The notice identifier field 95 is used to identify the type of recall notice that has been disseminated during a particular recall attempt.

The recall attempt table 75 further comprises an attempt date/time field 110. The attempt date/time field 110 is used according to one method of the present invention to record the date and/or the time when a particular recall notice was issued. According to one alternative embodiment of the present invention, the recall attempt table 75 further comprises an acknowledgment field 105. The acknowledgment field 105 is used by some variations of the inventive method to record receipt of an acknowledgment from a product that may have received a recall signal.

One example method of the present invention provides for creating a record in the recall attempt table 75 any time a recall signal is issued. Hence, a recall management system that implements this variation of the inventive method uses the recall attempt table 75 by creating a new record and storing any combination of a SKU number, a lot/date code and a serial number of a product in the new record. It should be noted, that various methods of the present invention may use various product identification schemes as a product index and that these may comprise the use of the SKU number, the lot/date code and the serial number either collectively, separately or in any combination.

Once the recall signal is issued, the method of the present invention provides for storing the date and/or time that the recall signal was issued. This is typically stored in the attempt date/time field 110 of the newly created record. If an acknowledgment is received in response to the recall signal, the method of the present invention provides for making an annotation in the acknowledgment field 105 of the newly created record. A unique identifier is stored in the attempt identifier field 100 in order to distinguish a particular record from other attempt records associated with the same product index. Likewise, one embodiment of the present invention determines the type of notice that was issued and stores some representation thereof in the notice identifier field 95 comprising the recall attempt table 75. According to one embodiment, a notice type number is stored in the notice identifier field 95.

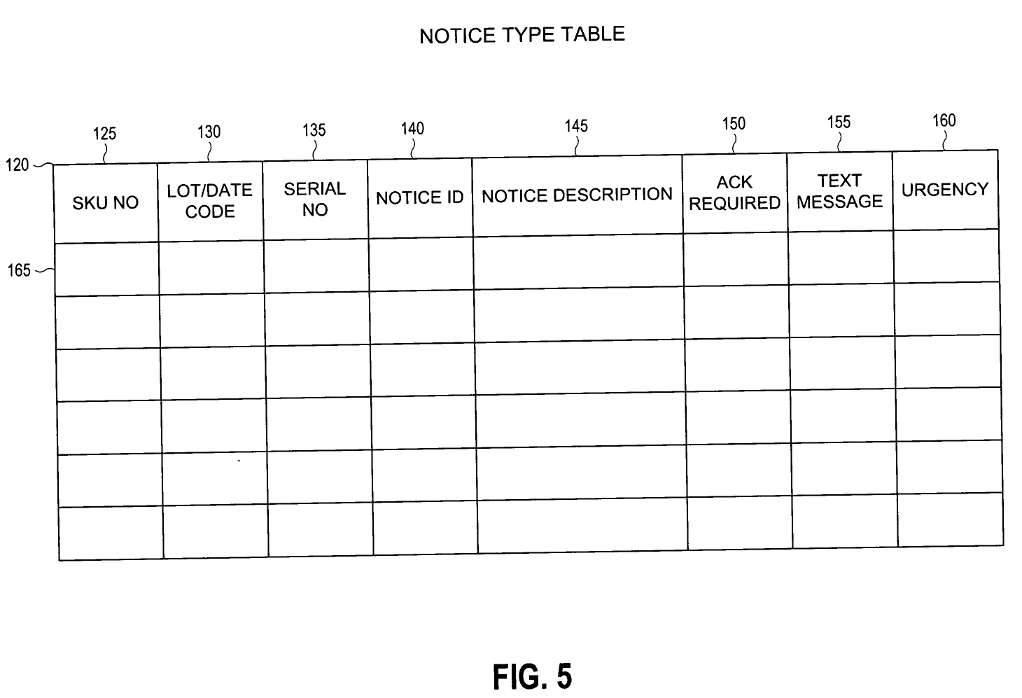

FIG. 5 is a pictorial representation of one possible structure of a notice type table that is used according to the present invention to manage recall notices. According to one variation of the present method, products may be subject to various types of notices. For instance, a product may be subject to a recall notice. Other types of notices may be disseminated to a product for the purposes of informing the consumer of product updates, product safety alerts and/or other types of messages that may be beneficial to the consumer in terms of use or safety of the product. These are just some of the types of notices that may be conveyed to a product and are not intended to limit the scope of the present invention. Other notices may include advertisements and product upgrade notices.

According to one method of the present invention, a notice is managed by creating a record for a new notice in a notice type table 120. According to one variation of the present method, the notice type table 120 comprises a product index that, as already illustrated, may comprise fields for a SKU number 125, a lot/date code 130 and a serial number 135. Depending on the method used for product indexing, the notice type table 120 comprises one or more of these fields. As already presented, the product index may utilize any or all of these fields either separately, collectively or in any combination.

Once a new notice type needs to be created, a new record is added to the notice type table 120. The SKU number field 125, the lot/date code field 130 and the serial number field 135 may all be set (collectively, separately or in any combination) to reflect a particular product according to the product indexing means utilized by any particular variation of the present method. For a particular product index, the unique value may be stored in the notice identifier field 140 comprising the newly created record.

According to one variation of the inventive method, a notice description further comprises a textual description of the notice. This textual description may be used for administrative purposes and is stored in the new record in a notice description field 145 that further comprises the notice type table 120 according to one alternative embodiment of the invention. According to some variations of the inventive method, a particular notice type may require receipt of an acknowledgment from the product that a recall signal has been received. In this case, a flag is set in the new record in an acknowledgment-required field 150 that further comprises the notice type table 120 in alternative embodiments of the invention that implement these methods.

One derivative of the example method taught here provides for a recall signal that comprises a textual message that is presented to a product user. In such case, the new record created for a new notice type further comprises a text message field 155 that is used to store the textual message that may be conveyed to the product user when the recall signal is issued. According to one variation of the present method, an urgency level is communicated to the product when a notice is thereto conveyed. Accordingly, one embodiment of the notice type table 120 further comprises an urgency field 160 that is used to store a criticality level for a newly created notice type.

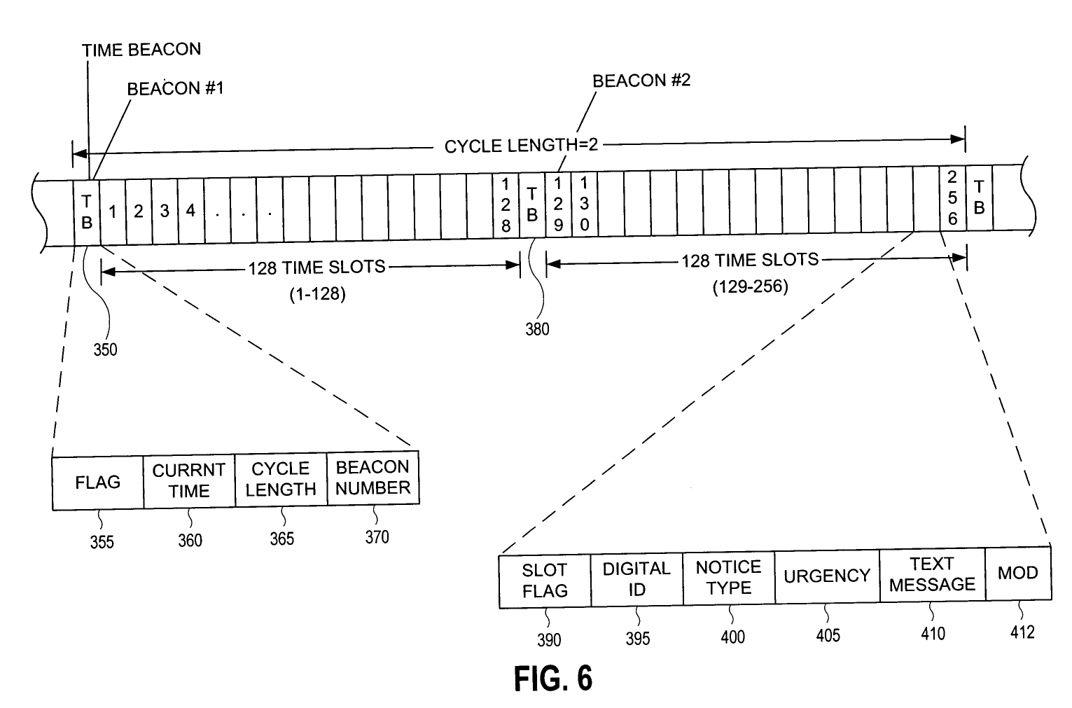

FIG. 6 is a pictorial representation that illustrates one possible method for time-multiplexing a communications channel into a plurality of time slots according to the present invention. Typically, recall signals and other messages are disseminated to products on an infrequent basis. Hence, the method of the present invention provides that a communications channel is partitioned into a plurality of time slots. This enables a communications channel to be shared amongst a plurality of various types of products and/or product groups. According to one method of the present invention, partitioning a communications channel allows selective monitoring of the channel by a receiving means comprising a product. A selective monitoring process may allow a receiving means to conserve electrical power by operating in a reduced power mode most of the time. The receiving means may then use additional power when it needs to detect a recall signal during a specific time slot.

According to one variation of the present method, a communications channel is used by first transmitting a time beacon 350. A time beacon 350 comprises a beacon flag 355. The beacon flag, according to one variation of the inventive method, comprises an indicator that indicates that a time beacon 350 is being conveyed onto the communications channel. The beacon flag, according to yet another variation of the present method, further comprises a time indicator 360. The time indicator 360 is used to convey to a receiving means the current time-of-day. Alternatively, the time indicator is used to convey a system time to a receiving means. According to one variation of the present method, the time beacon 350 further comprises a cycle length indicator 365. The cycle length indicator 365 is used to indicate the number of time beacons that are used in an overall cyclical signaling period. According to one illustrative use case as depicted in the figure, the cycle length indicator is set to the value of “2”. This indicates that two time beacons are used to complete a cyclical signaling period. The time beacon 350, according to yet another variation of the present method, further comprises a beacon number indicator 370. The beacon number indicator 370 is used to indicate the sequence number of a particular time beacon in an overall cyclical signaling period. Referring to the use case presented in the figure, the first time beacon 350 has its beacon number set to “1”. The second time beacon 380 has its beacon number set to “2”.

According to this variation of the present method, a plurality of time slots follow a particular time beacon. In one example method that is not intended to limit the scope of the present invention, 128 time slots follow a time beacon. Where the cycle length 365 indicated in the time beacon is “1”, the same 128 time slots will follow a subsequent time beacon. It should be noted, that in this illustrated use case, the time beacons will have the same beacon sequence number. Accordingly, were the cycle length 365 indicated in the time beacon is “2”, a second and distinct set of 128 time slots follow a second time beacon 380. Commensurate with this illustrative use case, the method of the present invention provides that the first time beacon 350 has its beacon sequence number 370 set to “1”. Likewise, the second time began 380 may have its beacon sequence number set to “2”. It should be noted, that all of these beacon sequence numbers, cycle lengths and the number of time slots that the following time beacon are all provided herein for the purpose of illustrating one method for time-multiplexing a communications channel according to the present invention. These illustrations are not meant to limit the scope of the present method or any apparatus that may comprise the invention.

FIG. 6 also illustrates one possible format for a recall signaling message that is conveyed to a product during a particular time slot according to the present invention. According to one illustrative method of the present invention, a receiving means that is intended to receive a recall signal monitors a communications channel during a particular time slot. After receiving a time beacon, the receiving means may then disable its detection circuitry in order to save power. This is discussed in greater of the detail infra.

According to one illustrative embodiment of the invention, a recall signaling message comprises a time slot flag 390. This time slot flag 390 is used to indicate the beginning of any time slot. The recall signaling message further comprises a digital identification number 395. The digital identification number 395 is used to target the recall signaling message to a particular product and/or group of products. It should be noted that the digital identification number, according to one embodiment of the invention, comprises a product identifier consistent with the definition herein established.

The recall signaling message, according to an alternative embodiment of the invention, further comprises a notice type indicator 400. This notice type indicator 400 is used to convey to a receiving means an identifier for a particular notice. The recall signaling message, according to yet another alternative embodiment of the invention, further comprises an urgency level indicator 405. The urgency level indicator 405 indicates the level of criticality of a concern or defect that spawned the issuance of a particular recall signal. According to one alternative method that further illustrates of the present invention, the recall signaling message further comprises a text message 410. This test message 410 is used to convey a textual message to a receiving means.

According to one derivative of the present method, a recall signaling message further comprises a modulus indicator 412. Normally, a receiving means monitors a particular time slot associated with a particular time beacon in order to receive recall signals. Where the cycle length, i.e. the number of distinct time beacons, is large, the frequency of a particular time slot may be too low to provide timely receipt of a signaling message by a particular type of product. Hence, the method of the present invention may direct the product to use a plurality of time slots that are associative with a plurality of distinct time beacons. This may be done by setting the value of the modulus indicator 412 in order to instruct a particular product to use a particular number of time beacons and/or time slots within a cyclical signaling period.

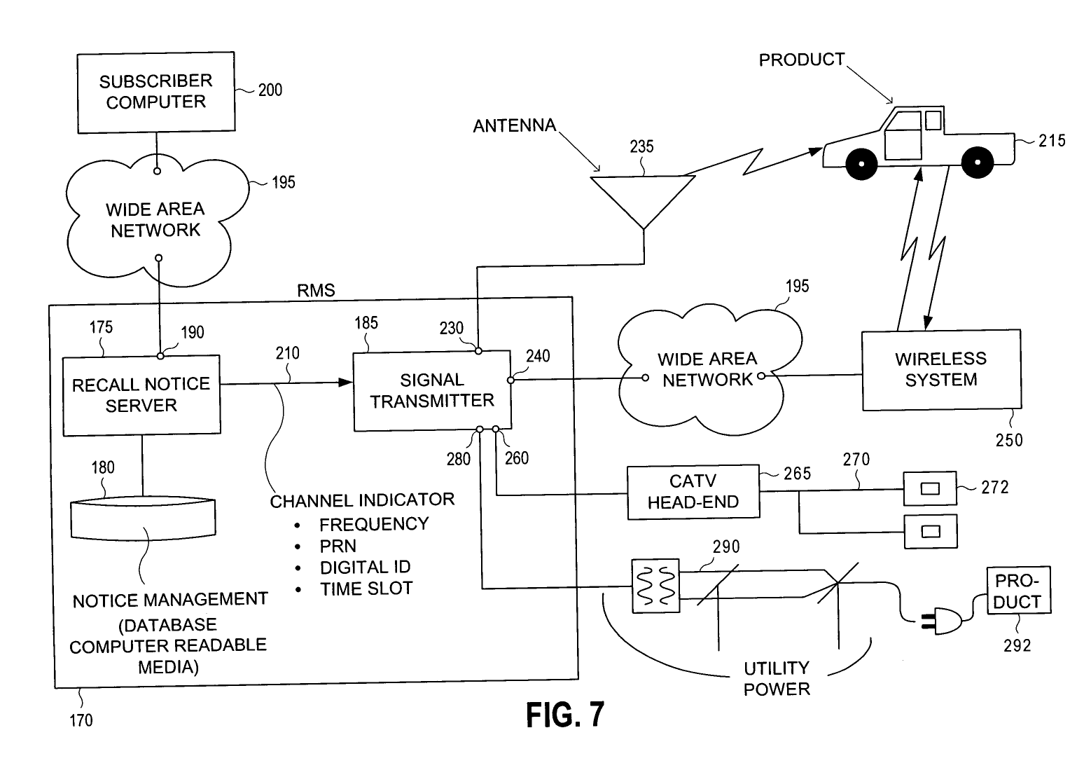

FIG. 7 is a pictorial representation of a recall management system that is capable of issuing a recall signal to a product according to the present invention. According to one embodiment of the present invention, recall signals are disseminated to either an individual product or to a collection of products that are the subject of a recall (i.e. the target product group). Such a recall signal is issued by the recall management system 170. A typical RMS 170 comprises a recall notice server 175, a notice management database 180 that is stored on computer readable media and a signal transmitter 185. According to one embodiment of the present invention, the notice management database 80 is used to store a channel table 35, a recall attempt table 75 and a notice type table 120 commensurate with the teachings of the present method. The recall notice server 175 acts as a signal generator that generates recall messages in accordance with the teachings of the present invention.

According to one embodiment of the invention, the recall notice server 175 comprises a wide area network interface 190. In one example application of the present invention, the wide area network interface 190 is used to attach the recall notice server 175 to a wide area network 195 (e.g. the Internet). In such a configuration, a manufacturer or other entity that is interested in issuing a recall notice may do so by attaching a subscriber computer 200 to the wide area network. The recall notice server 175 may then be accessed over the wide area network 195 by the subscriber computer 200 in order to manage recall notice types and the issuance of a particular recall notice. According to one embodiment of the present invention, the subscriber computer 200 may also interact with the recall notice server 175 to obtain recall notice acknowledgment data from the notice management database 180.

According to one alternative embodiment of the present invention, the subscriber computer 200 interacts with the recall notice server 175 through the use of web pages that are stored on the recall notice server 175. Some of these web pages reflect the contents of the notice management database 180. Other web pages are used to manage the contents of the notice management database 180 attached to the recall notice server 175. It should be noted that management of the contents of the notice management database 180 is not necessarily limited to the use of web pages over a wide area network. According to one alternative embodiment, a local terminal is attached to the recall notice server 175 and is used to manage the contents of the notice management database 180 and to cause the RMS 170 to issue a recall signal.

In operation, once the recall notice server 175 has received an indication that a particular recall notice must be issued for a particular product, it uses the product index to consult the channel table 35 that is stored in the notice management database 180. The recall notice server then discovers the channel that may be used to convey a notice to a particular product. Using a product SKU number, lot/date code and serial number either separately, collectively or in any combination as a product index to select a particular record in the channel table 35, the recall notice server 175 retrieves one or more of a channel number 55, a digital identification number, a PRN value, a telephone number and a timeslot that may correspond to a particular product type. Again, the recall notice server 175 may use any of these either singularly, collectively or in any combination to specify a channel path that may be used to issue a recall, or other product notice signal to the subject product. According to one alternative embodiment, the digital identification number comprises the product identifier (i.e. any combination of a product SKU number, lot/date code and serial number).

Having identified the proper channel, the recall notice server 175 issues a signal command 210 to the signal transmitter 185. According to one alternative embodiment of the present invention, the signal command 210 comprises either separately, collectively or in any combination a channel indicator comprising a channel number (i.e. frequency), PRN value, digital identifier, telephone number and timeslot. The signal transmitter 185 then uses the channel indicator to route a recall signal to the target product 215.

According to one alternative embodiment, the recall notice server 175 further consults the notice type table 120 in order to retrieve an urgency level. And, according to one alternative embodiment, the recall notice server 175 retrieves a textual message from a particular record in the notice type table 120 according to the product index and a notice identifier. This information is included in a signal command 210 that the recall notice server 175 dispatches to the signal transmitter 185. The signal transmitter 185 of one embodiment incorporates the urgency level into the recall signal that it conveys to the target product 215 (e.g. by conveying the message to a determined channel). According to one alternative example embodiment of the invention, the signal transmitter 185 included a textual message into the recall signal that it conveys to the target product 215. The recall notice server 175, according to yet another illustrative embodiment of the invention, also determines if a particular notice requires acknowledgment from the product that is the subject of the recall notice. This is done by consulting the acknowledgment field 150 that comprises the notice type table 120. This information may further comprise the signal command 210. Some variations of the present method may not include an urgency level in the signal command 210. According to other variations of the present method, a signal command 210 also comprises the notice type identifier that is used to indicate to the receiving means the type of notice that spawned the recall signal. But typically, this notice type indicator corresponds to a notice identifier for a particular notice type reflected by the record in the notice type table 120 that is stored in the notice management database 180.

According to one embodiment of the present invention, once the recall notice server 175 issues the signal command 210 to the signal transmitter 185, it creates a new record in a recall attempt table 75 that is stored in the notice management database 180. Once the new record is created, the product index corresponding to the recall notice is stored into any combination of a SKU number field 80, a lot/date code field(s) 85 and a serial number field 90 that may comprise the recall attempt table. An identifier representing the type of notice that was issued is be stored in a notice identifier field 95 comprising the table.

For every new record created for a particular product index, a unique identifier is stored in an attempt identifier field 100. The date and/or the time that the signal command 210 was dispatch to the signal transmitter 185 is also recorded in the newly created record. In those embodiments where the signal transmitter is notified by way of the signal command 210 that at a particular notice type requires acknowledgment from the product, the recall notice server 175 stores the results of any received acknowledgment in an acknowledgment field 105 comprising the newly created record.

The signal transmitter 185 comprising the present invention may itself comprise an RF interface 230. According to one example embodiment where a recall signal is wirelessly conveyed to a product 215, the signal transmitter 185 causes an RF signal to emanate from the RF interface 230. This is then directed to an antenna 235 that radiates the RF signal in to free-space.

According to one alternative embodiment of the present invention, the signal transmitter 185 comprises a spread-spectrum interface capable of communication in a spread-spectrum mode and further capable of receiving a PRN sequence. The PRN sequence used to feed the spread-spectrum interface is extracted from the signal command 210. The output of the spread-spectrum interface may then be directed to an antenna 235 that may then radiate the RF signal through the ether.

The signal transmitter 185, according to one alternative embodiment, comprises a wide area network interface 240. In the case where a recall signal is conveyed to a product 215 by means of a networking structure, the signal transmitter 185 uses a digital identifier number that may comprise the signal command 210 to propagate the recall signal to the wide area network 195. In some embodiments, the product 215 communicates with the wide area network by wireless means. Hence, where the product recall signal receiving means comprising the product 215 interfaces with a wireless networking system 250, the recall signal is conveyed to the wide area network 195 and then routed to the wireless system 250. One example embodiment of a wireless system that is used to convey a recall signal to a product is a 2G wireless infrastructure. A 3G wireless infrastructure is used in one alternative embodiment of the invention. It should be noted, that the present invention may utilize any wireless networking structure to convey a recall signal to a product and the examples set forth here are not intended to limit the scope of the present invention. For example, a cellular telephone system is used by one embodiment of the invention where the communications channel to a particular product is specified by a telephone number.

According to one alternative embodiment of the present invention, the signal transmitter comprises a cable television system interface 260. The cable television system interface 260 is used by the signal transmitter 185 to convey the recall signal to a cable television system head-end 265. A cable television distribution system 270 may then be used to convey a recall signal to a product 272 that may be the subject of a recall.

According to yet another alternative embodiment of this invention, the signal transmitter comprises a utility power interface 280. The signal transmitter 185 uses the utility power interface 280 to convey a recall signal to a utility power distribution system 290. Products 292 that may be attached to the utility power distribution system may then received the recall signal that may be carried by the utility power distribution system 290.

According to yet another example embodiment of the invention, the channel indicator 210 received by the signal transmitter 185 comprises a telephone number. In this case, the signal transmitter comprises a telephone interface that enables the signal transmitter to place a telephone call through a switched telephone network according to the telephone number. The signal transmitter then conveys the recall signal to the product using the communications channel established to the product through the switched telephone network.

According to one example embodiment of the present invention, the signal transmitter 185 time-multiplexes a particular communications channel. According to one alternative embodiment of the present invention, the signal transmitter 185 transmits a time beacon according to the teachings of the present method. The signal transmitter 185 then conveys a recall signal message to a particular product during a particular time slot. According to yet another alternative embodiment of the present invention, the signal transmitter 185 transmits a plurality of recall signal messages during a corresponding number of time slots that follow a time beacon. A separate and distinct plurality of time slots may follow a second time beacon. It should be noted that the signal transmitter 185, according to one alternative embodiment, implements the method of the present invention by establishing a cycle length for an overall cyclical signaling period. The cycle length typically defines the number of distinct time beacons and associated sets of time slots that comprise the overall cyclical singling period.

According to one method of the present invention, as embodied in the signal transmitter 185, the digital identification number of a particular product is segregated into two distinct fields; product identifier and time slot. Hence, when a particular product needs to be signaled, the signal transmitter 185 uses the time slot field of the digital identification number as a means of determining which time slot should be used to convey a recall signaling message to the product.

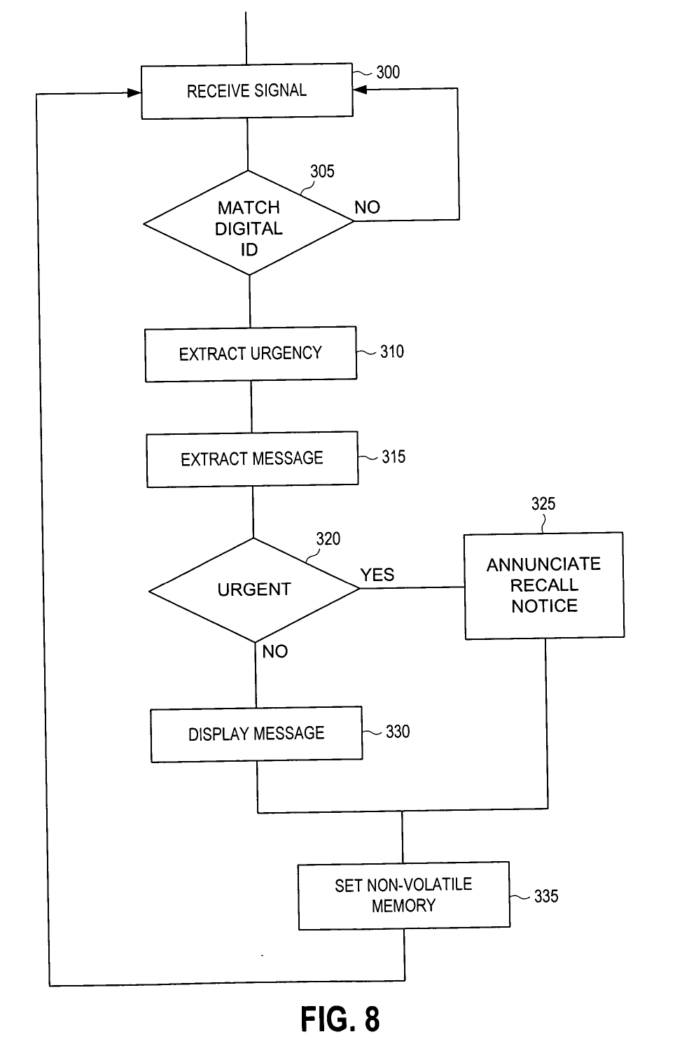

FIG. 8 is a flow diagram that depicts one example process for receiving a product recall signal according to the present invention. The present invention further comprises a method for receiving a recall signal in a product. According to one illustrative method, the signal is received (step 300). Where the method used to disseminate the recall signal modifies the signal using a digital identification number, the receiving method comprises a step for matching the digital identification number (step 305). Typically, a unique digital identification number is assigned to each type of product and/or group of products that may be the subject of a recall.

In the event of a successful comparison of the digital identification number to a value that is stored in the product receiving means, one example variation of the present method provides for extracting an urgency level from the recall signal (step 310). It should be noted that extraction of an urgency level may only apply when the method used to disseminate a recall signal utilizes a recall signal that comprises an urgency indicator. In yet other derivatives of the inventive method taught here, the recall signal comprises a textual message. In this case, the method of the present invention for receiving a recall signal provides for extracting the textual message from the recall signal (step 315). In yet another alternative method, the mere fact that a message was received is indicative of a pending recall.

Where a recall signal comprising an urgency level is received and the urgency level is subsequently extracted from the recall signal, one illustrative method provides for special processing for certain urgency levels. According to one example method, if a recall is urgent (step 320) the method of the present invention provides for an audible annunciation of the recall notice (step 325). For other than an urgent recall signal, the method of the present invention provides for displaying a textual message (step 330), in those cases where a received recall signal comprises a textual message. According to one alternative method, a user is notified once a message is received.

According to yet another alternative variation of the present method, an optional step is provided for setting a non-volatile memory once a recall signal is received (step 335). The purpose of setting a non-volatile memory is to enable a permanent record that a receiving means comprising the product that is the subject of a recall has actually received the recall signal. This permanent record may serve as important evidence in a legal proceeding where a manufacturer or other entity claims that the recall signal was in fact issued and received by the receiving means. According to one derivative of this method, setting of the non-volatile memory comprises breaking a fusible link that can later be physically and/or optically examined in order to determine the state of the non-volatile memory. In yet another variation of this method, the nonvolatile memory is set according to a notice type indicator wherein the recall signal received such an indicator as part of a recall notice. The non-volatile memory, according to one example method, is set with one or more of a message receipt indication, a time-stamp, an urgency level and a text message. The time stamp comprises either a system time or current time of day as maintained by the clock that continues to operate in the receiving means.

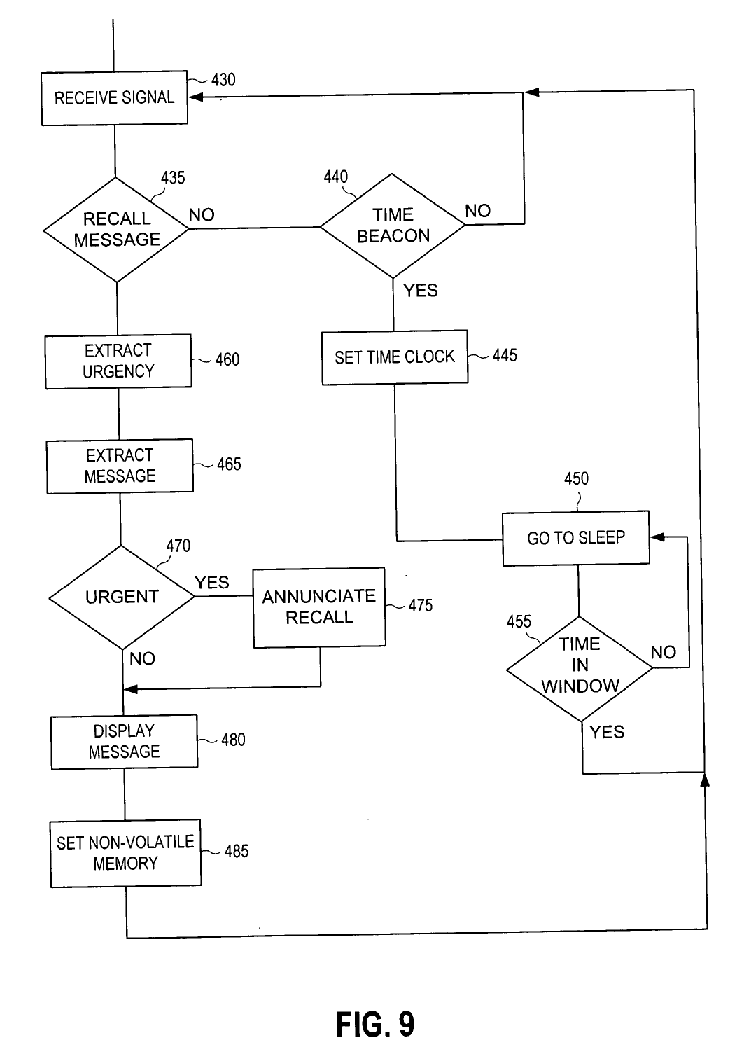

FIG. 9 is a flow diagram that depicts one illustrative, alternative method for receiving a recall signal during a particular time slot according to the present invention. According to this variation of the present method, a receiving means receives a signal (step 430). Typically, a receiving means starts operation and looks for one of two types of signals. According to one alternative method, either of a recall message (step 435) or a time beacon (step 440) is recognized. In the event that the receiving means recognizes a time beacon, it extracts the current time-of-day (or system time) from the time beacon and sets an internal time clock to the current time (step 445). The receiving means then maintains the time of day as the internal clock continues to operate after it is set according to this method.

Because many products that may be the subject of a recall signal do not traditionally require any electrical power or signaling, a receiving means may need to operate in a low-power mode in order to conserve power. Hence, once the receiving means recognizes the time beacon and sets its own internal clock, it goes to sleep (step 450) until it recognizes that it should detect a recall signal. Typically, the receiving means will remain in a low-power state until it particular time slot occurs (step 455). At that point, the method of the present invention provides for receiving a signal (step 430). This requires additional power to operate detection circuitry comprising the receiving means that is capable of receiving a signal.

According to one method of the present invention, a receiving means determines what time slot to use based on a digital identification number that dictates what type of product and/or group of products the receiving means is affiliated with. According to one variation of this method, the digital identification number is segregated into two fields, as discussed supra. The receiving means uses the time slot field comprising the digital identification number to select a particular time slot as the time interval in which to monitor the communications channel for a recall signal. According to yet another derivative of the illustrative method described here, the receiving means further extracts a modulus indicator from a recall signaling message in order to determine if the receiving means should monitor the communications channel during multiple time slots.

According to one method of the present invention, the receiving means actively monitors the communications channel in order to detect a recall signal in one of two states; upon initial start-up or during a designated time slot. In either of these monitoring states, if a signal is received and is recognized as a recall message (step 435), the receiving means optionally extracts an urgency indicator (step 460). The receiving means also optionally extracts a textual message (step 465). In those variations of the present method that extract an urgency indicator, the urgency indicator is compared to an urgency threshold (step 470). If the urgency indicator comprising the message indicates a level of urgency beyond the urgency threshold, the present method provides for annunciation of the recall notice to a user (step 475). In those variations of the present method that extract a textual message from the signal, the message is then displayed to a user (step 480). It should be noted that, in a general sense of the present method, the receipt of a notice message results in an indication to a product user. For example, the receipt of a recall message, according to one illustrative embodiment of the method, results in enabling a visual indicator (e.g. a light emitting diode).

According to one derivative of the present illustrative method, once the receiving means has provided an indication to a user either by annunciation, indication or textual display, it then permanently records a notation that indicates that a recall signal was received. This permanent record is stored in a non-volatile memory (step 485). Typically, the non-volatile memory comprises a device whose state may be determined by observation. Some techniques for observing the state of a non-volatile memory may be through optical examination, electrical observation, by scanning electron microscope or by x-ray. It should be noted that the method of the present invention should not be limited to applications where the non-volatile memory may be examined by any of the enumerated techniques; these are meant to illustrate, but not limit the scope of the present invention. Other types of non-volatile memory are used by variations of the present method including, but not limited to magnetic memory and battery-backed-up random access semiconductor memory. According to one alternative method, an indicator reflecting the type of notice that was received is permanently recorded. According to one alternative method, the textual message that was received is permanently recorded. According to one alternative method, an indicator reflecting the time at which the notice that was received is permanently recorded. Time, according to one variation of the present method, is stored in either of a time-of-day or a system time format.

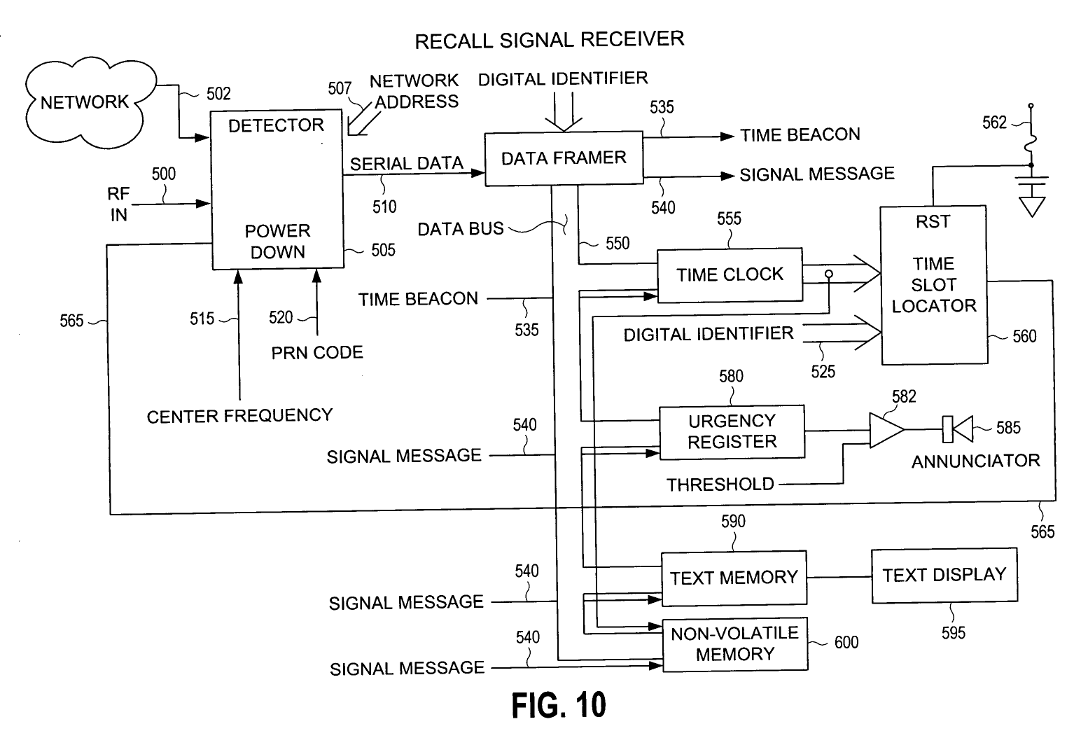

FIG. 10 is a block diagram of one example embodiment of a receiving means that is capable of receiving a recall signal according to the present invention. A product that may be the subject of a recall may be augmented with the receiving means described herein for the purpose of enabling the product to receive a recall signal. Hence, a product may comprise said receiving means. According to one example embodiment, the receiving means comprises a detector 505 for detecting a signal that may be conveyed to the receiving means by a communications channel. The detector 505 may comprise various internal structures according to the type of communications channel that may be used to convey a recall signal to the receiving means.

According to one illustrative embodiment of the present invention, the detector 505 comprises a tuner that is capable of receiving a radio frequency (RF) signal by way of an RF input 500. According to this embodiment, the tuner selectively amplifies a particular portion of the frequency spectrum that may be present at the RF input 500. The RF input generally receives RF signals by means of an antenna, but it may be connected to some form of physical medium (e.g. a cable television distribution system). According to various embodiments of the present invention, the tuner selects a narrow band frequency carrier that is modulated by one or more of amplitude, frequency and phase. The tuner selects this narrow band frequency according to a center frequency indicator 515. According to one embodiment of this invention, the center frequency indicator 515 is a pre-established value. It should be noted that the scope of the present invention is not intended to be limited to any particular form of modulation that may be used to convey information by way of the RF signal.

Yet another embodiment of the present invention provides that the detector 505 comprises a spread-spectrum receiver. In this case, the spread-spectrum receiver accepts a PRN sequence identifier 520. The PRN sequence identifier 520, according to one embodiment, is a pre-established value. Generally, the PRN sequence identifier 520 cause the detector 505 to change frequencies according to the particular random sequence.

According to another embodiment of the present invention, the detector 505 comprises a network interface circuit that comprises a network interface 502. According to this embodiment of the invention, the detector monitors activity on a digital network 504. In this case, the detector 505 requires a network address 507 in order to recognized network traffic that is targeted to the detector 505. Typically, the network address is associated with a particular product and/or group of products. According to one embodiment, the network interface comprises a wired interface. According to yet another embodiment, the network interface comprises a wireless network interface.

According to yet another embodiment of the present invention, the detector 505 comprises a wired telephone interface. In this case, the wired telephone interface enables the detector to receive a phone call from a wired telephone network and to receive a recall signal once the phone call is answered. Typically, the detector further comprises a modem for converting a modulated signal into digital data.

According to another embodiment of the present invention, the detector 505 comprises a wireless telephone interface (e.g. a cellular telephone circuit). In this case, the wireless telephone interface enables the detector to receive a phone call from a wireless telephone network and to receive a recall signal once the phone call is answered. Typically, the detector further comprises a modem for converting a modulated signal into digital data. According to one alternative embodiment, the detector comprises a network interface circuit that enables direct digital reception from a wireless cellular network (e.g. a 2G or 3G interface).

Irrespective of the type of communications channel that is used to receive a recall signal, the detector 505, according to one example embodiment, further comprise a power-down command input. This power-down command input is driven by a time-slot signal. The time-slot signal indicates to the detector 505 that it should anticipate receiving a recall signal. When the time-slot signal is not active, the detector 505 enters a power-down state wherein it conserves power until the time-slot signal again becomes active.

Once the detector 505 perceives an active recall (or other product notice) signal, it converts the signal into a serial data stream 510. The serial data stream 510 then is conveyed to a data framer 530 that also comprises the receiving means. According to one illustrative embodiment of the present invention, the data framer 530 accepts a digital identifier 525. The digital identifier 525 normally comprises a pre-established value that may be associated with a particular type of product and/or group of products. According to one embodiment of the present invention, the data framer 530 scans the serial data stream 510 in order to identify two types of messages; a time beacon or a recall signaling message.

This illustrative embodiment of the present invention provides that when the data framer 530 identifies a time beacon, it issues a time beacon capture signal 535. The data framer 530 creates a representation of the incoming serial data stream 510 according to a particular message format. Hence, when the time beacon capture signal 535 is active, the data framer 535 concurrently provides the time-of-day (or system time) value onto a data bus 550. It should be noted that the time-of-day value presented to the data bus 550 is typically recovered from the serial data stream 510 according to the particular message format corresponding to a time beacon message. The time-of-day (or system time) value carried by the data bus 550 is stored in a time clock 555 further comprising the receiving means.

According to yet another alternative embodiment of the present invention, the receiving means further comprises a time slot locator 560. The time slot locator 560 receives a current time-of-day (or system time) from the time clock 555. The current time-of-day maintained by the time clock 555 is used to enable a time-slot signal 565. According to one alternative embodiment, a portion of the digital identifier 525 is compared to the current time in order to enable the time-slot signal 565. The time-slot signal 565 is used the two indicate to the detector 505 that it may anticipate the arrival of a recall signal. According to one alternative embodiment of the present invention, the time slot locator 560 issues the time-slot signal 565 immediately after the receiving means begins operating. This is accomplished by a power on reset circuit 562. The time-slot signal 565 is maintained until the data framer 530 recognizes a time beacon message.

When the data framer 530 recognizes a recall signal in the serial data stream 510, it compares a portion of the recall signaling message to the digital identifier 525. If this digital identification portion of the recall signaling message is successively compared with the digital identifier 525, the data framer 530 issues a signal message capture signal 540. Data comprising the recall signaling message are also conveyed to the data bus 550 in this instance and is captured commensurate with the signal message capture signal 540.

According to one alternative embodiment of the present invention, the receiving means further comprise an urgency register 580, an urgency comparator 582 and an annunciator 585. The data framer 530 provides a portion of the recall signaling message onto the data bus 550. This portion of the recall signaling message indicates an urgency level for that signaling message. This indication is then stored in the urgency register 580 according to an active signal message capture signal 540. It should be noted that, according to one alternative embodiment of the invention, the active signal message capture signal 540 is used to activate a simple user indicator, for example a light emitting diode. According to yet another alternative embodiment, the receiving means further comprises said indicator.

According to yet another alternative embodiment of the present invention, the receiving means further comprises a text memory 590. A textual message that may comprise a recall signaling message as perceived by the data framer 530 is stored in the text memory 590 commensurate with the signal message capture signal 540. The text that is stored in the text memory 590 is then displayed on a textual display 595 that, according to one alternative embodiment, further comprises the invention.

In yet one additional illustrative embodiment of the present invention, the receiving means further comprises a nonvolatile memory 600. According to one alternative embodiment, the nonvolatile memory 600 comprises a device whose state may be determined by observation. This may include a fusible link memory device. It should be noted that the scope of the present invention should not be limited to this one illustrative example of a nonvolatile memory device. The nonvolatile memory 600 is used to store a portion of the data bus 550 when the signal message capture signal 540 is active. The portion of the data bus 550 that may be saved in the nonvolatile memory device 600 comprises a notice identifier that may be used to identify the type of recall signal that was received. According to one alternative embodiment, the non-volatile memory is caused to store the time-of-day (or system time) as maintained by the time clock 555 when the signal message capture signal 540 is active.

Alternative Embodiments

While this invention has been described in terms of several example embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

According to some methods and embodiments of the present invention, an annunciator may be used to call a product users attention to a pending recall signal. In one alternative method and apparatus, an audible annunciator may be replaced or augmented by a visual indicator. A light emitting diode and an incandescent indicator are just two examples of visual indicators that may be used. This enumeration is meant to illustrate possible visual indicators and is not meant to limit the scope of the present invention.

Most importantly, as noted above, the method and the apparatus of the present invention may be utilized with a wide variety of message types including, but not limited to recall messages, product update messages and advertisements. Hence, in all instances where this specification describes application of the invention to recall notices, alternative embodiments that are applied in product update messages and advertisements are also intended to be within the scope of the appended claims.

I claim:

1. A method for issuing a notice to a product comprising the steps of:
accepting a product identifier;
generating a signal message according to the product identifier; and
conveying the signal message to the product.

2. The method of claim 1 wherein accepting a product identifier comprises accepting one or more of a stock keeping unit number, a serial number, a lot code and a date code.

3. The method of claim 1 wherein generating a signal message comprises generating a signal message that includes the product identifier.

4. The method of claim 1 wherein generating a signal message comprises:
determining a digital identification number associated with the product identifier; and
including the digital identification number in a signal message.

5. The method of claim 1 wherein conveying the signal message to the product comprises:
determining a target product group;
determining a communications channel according to the target product group; and
conveying the signal message to the communications channel.

6. The method of claim 5 wherein determining a communications channel comprises determining on one or more of a carrier signal frequency, a numeric sequence, a network address and a telephone number for a target product group.

7. The method of claim 1 wherein conveying the signal message to the product comprises:
determining a conveyance time slot associated with the product; and
conveying the signal message to the communications channel during the time slot on a periodic basis.

8. The method of claim 1 further comprising conveying a time beacon to the product.

9. A method for issuing a notice to a product comprising the steps of:
accepting a product identifier;
determining a communications channel to a product;
generating a signal message; and
conveying the signal message to the communications channel.

10. The method of claim 9 wherein accepting a product identifier comprises accepting one or more of a stock keeping unit number, a serial number, a lot code and a date code.

11. The method of claim 9 wherein determining a communications channel comprises determining one or more of a carrier signal frequency, pseudo random number sequence, a network address and a telephone number.

12. The method of claim 9 wherein generating a signal message comprises generating a signal message that includes the product identifier.

13. The method of claim 9 wherein generating a signal message comprises:
determining a digital identification number associated with the product identifier; and
including the digital identification number in a signal message.

14. The method of claim 9 wherein conveying the signal message to the communications channel comprises conveying the signal message to at least one of a wired communication medium and a wireless communications medium.

15. The method of claim 9 wherein conveying the signal message to the communications channel comprises conveying the signal message to at least one of a cable television distribution system, a utility power distribution system and a switched telephone network.

16. The method of claim 9 wherein conveying the signal message to the communications channel comprises:
determining a conveyance time slot associated with the product; and
conveying the signal message to the communications channel during the time slot.

17. The method of claim 9 wherein conveying the signal message to the communications channel comprises conveying the signal message to the communications channel on a periodic basis.

18. The method of claim 9 further comprising conveying a time beacon to the communications channel.

19. The method of claim 9 further comprising receiving an acknowledgement of the signal message from the product.

20. An apparatus for conveying a notice to a product comprising:
product identification unit that accepts a product identifier;
signal generator that is capable of generating a signal message according to the product identifier; and
signal transmitter that is capable of conveying the signal message to the product.

21. The apparatus of claim 20 wherein the product identification unit is capable of accepting one or more of a stock keeping unit number, a serial number, a lot code and a date code.

22. The apparatus of claim 20 wherein the signal generator generates a signal message based that includes the product identifier.

23. The apparatus of claim 20 wherein the signal generator:
determines or receives a digital identification number associated with the product identifier; and
generates a signal message that includes the digital identification number.

24. The apparatus of claim 20 wherein the signal transmitter comprises:
channel indicator receiver capable of receiving a channel indicator; and
interface wherein the signal transmitter dispatches to the interface a signal message directed according to the channel indicator.

25. The apparatus of claim 24 wherein the interface comprises of at least one of a radio frequency interface, a spread-spectrum interface, a network interface, a telephone interface, and a cellular telephone interface.

26. The apparatus of claim 20 wherein the signal transmitter is capable of conveying the signal message to the product during a particular time slot.

27. The apparatus of claim 20 wherein the signal transmitter is capable of conveying the signal message to the product on a periodic basis.

28. The apparatus of claim 20 wherein the signal transmitter is capable of conveying a time beacon to the product.

29. An apparatus for conveying a notice to a product comprising:
product identification unit that accepts a product identifier;
communications interface configurable according to the product identifier; and
signal generator that generates a signal message according to the product identifier and conveys the signal message to the communications channel.

30. The apparatus of claim 29 wherein the product identification unit accepts a product identifier in at least one of the formats including a stock keeping unit number, a serial number, a lot code and a date code.

31. The apparatus of claim 29 wherein the communications interface is configurable according to at least one of a carrier signal identifier, pseudo random number sequence, a network address and a telephone number.

32. The apparatus of claim 29 wherein signal generator generates a signal message that includes the product identifier.

33. The apparatus of claim 20 wherein the signal generator:
determines or receives a digital identification number associated with the product identifier; and
generates a signal message that includes the digital identification number.

34. The apparatus of claim 29 wherein the communications interface comprises at least one of a wired and a wireless interface.

35. The apparatus of claim 29 wherein the communications interface comprises at least one of a cable television interface, a utility power interface and a switched telephone network interface.

36. The apparatus of claim 29 wherein the communications interface further comprises a time-slot unit that determines or receives a time-slot associated with the product and also conveys the signal message to the product during the determined time-slot.

37. The apparatus of claim 29 wherein the signal generator is capable of conveying the signal message to the communications channel on a periodic basis.

38. The apparatus of claim 29 wherein the signal generator is capable of conveying a time beacon message to communications channel.

39. The apparatus of claim 29 wherein the signal generator is capable of recording an acknowledgement from the product.
